(19) United States
(12) Patent Application Publication
(10) Pub. No.: US 2014/0076727 A1
(43) Pub. Date: Mar. 20, 2014

(54) ELECTROPHORESIS-GEL-FORMING MONOMER SOLUTION, SOLUTION EJECTING METHOD, METHOD FOR FORMING ELECTROPHORESIS GEL, ELECTROPHORESIS GEL, AND ELECTROPHORESIS REACTION INSTRUMENT

(71) Applicants: Hiroshi Ohki, Osaka-shi (JP); Hiroshi Yamaki, Osaka-shi (JP); Yutaka Unuma, Osaka-shi (JP); Yuji Maruo, Osaka-shi (JP); Tsuyoshi Tanaka, Osaka-shi (JP)

(72) Inventors: Hiroshi Ohki, Osaka-shi (JP); Hiroshi Yamaki, Osaka-shi (JP); Yutaka Unuma, Osaka-shi (JP); Yuji Maruo, Osaka-shi (JP); Tsuyoshi Tanaka, Osaka-shi (JP)

(21) Appl. No.: 14/007,748

(22) PCT Filed: Mar. 27, 2012
(86) PCT No.: PCT/JP2012/057876

§ 371 Date: Dec. 3, 2013

(30) Foreign Application Priority Data
Mar. 29, 2011 (JP) 2011-072885

(51) Int. Cl. G01N 27/447

(52) U.S. Cl. CPC G01N 27/447
USPC 204/470; 204/615

(57) ABSTRACT

A solution ejecting method includes a first ejection step of ejecting an electrophoresis-gel-forming monomer solution containing at least a monomer that forms a gel structure and a gel polymerization accelerator that activates a gel polymerization initiator and a second ejection step of ejecting a gel polymerization initiating solution containing the gel polymerization initiator onto the electrophoresis-gel-forming monomer solution.

### TECHNICAL FIELD

The present invention relates to an electrophoresis-gel-forming monomer solution, a solution ejecting method, a method for forming an electrophoresis gel, an electrophoresis gel, and an electrophoresis reaction instrument.

This application claims priority based on Japanese Patent Application No. 2011-072885 filed in Japan on Mar. 29, 2011, the contents of which are hereby incorporated by reference herein.

### BACKGROUND ART

Electrophoresis is a phenomenon in which charged particles or molecules move under an electric field. Electrophoresis is particularly important as a method for separating DNA or proteins in the fields of molecular biology and biochemistry.

Two-dimensional electrophoresis has been widely used as one of methods for separating proteins in order to analyze proteosomes that have been receiving attention in post-genome research.

Two-dimensional electrophoresis is a method for two-dimensionally separating proteins using two-stage electrophoresis.

For example, in first-dimensional separation, proteins are separated by isoelectric focusing (IEF) that uses an immobilized pH gradient gel (IPG gel). In second-dimensional separation, proteins are separated by sodium dodecyl sulfate-polyacrylamide gel electrophoresis (SDS-PAGE) in terms of molecular weight.

In recent years, the frequency of use of a gel electrophoresis method for plant and animal genome analysis has been remarkably increasing, and therefore a technique for uniformly producing a gel plate for electrophoresis with high productivity has been demanded.

A method that uses an inkjet method is known as a method for producing such a gel plate for electrophoresis (e.g., refer to PTL 1).

### CITATION LIST

### Patent Literature

PTL 1: Japanese Unexamined Patent Application Publication No. 2004-77393

### SUMMARY OF INVENTION

### Technical Problem

However, an electrophoresis-gel-forming solution used in PTL 1 contains gel particles, which poses a problem in that a nozzle having a minute orifice and disposed on an inkjet head is clogged.

In view of the foregoing, it is an object of the present invention to provide an electrophoresis-gel-forming monomer solution that enables the control of the timing at which gelation starts, a method for ejecting the solution, a method for forming an electrophoresis gel, an electrophoresis gel, and an electrophoresis reaction instrument.

### Solution to Problem

(1) An electrophoresis-gel-forming monomer solution according to a first aspect of the present invention at least includes a monomer that forms a gel structure and a gel polymerization accelerator that activates a gel polymerization initiator.

(2) In the electrophoresis-gel-forming monomer solution according to the first aspect of the present invention, the monomer is preferably a radically polymerizable substance.

(3) In the electrophoresis-gel-forming monomer solution according to the first aspect of the present invention, the radically polymerizable substance is preferably at least one selected from the group consisting of acrylamide, N,N′-methylenebisacrylamide, and acrylamide derivatives.

(4) In the electrophoresis-gel-forming monomer solution according to the first aspect of the present invention, the gel polymerization accelerator is preferably tetramethylethylenediamine.

(5) A solution ejecting method according to a second aspect of the present invention includes a first ejection step of ejecting an electrophoresis-gel-forming monomer solution containing at least a monomer that forms a gel structure and a gel polymerization accelerator that activates a gel polymerization initiator and a second ejection step of ejecting a gel polymerization initiating solution containing the gel polymerization initiator onto the electrophoresis-gel-forming monomer solution.

(6) In the solution ejecting method according to the second aspect of the present invention, in the first ejection step, the electrophoresis-gel-forming monomer solution is preferably ejected such that a concentration gradient is formed in one direction of an ejection surface of an ejection object.

(7) In the solution ejecting method according to the second aspect of the present invention, in the first ejection step, the electrophoresis-gel-forming monomer solution is preferably ejected a plurality of times.

(8) In the solution ejecting method according to the second aspect of the present invention, the monomer is preferably a radically polymerizable substance.

(9) In the solution ejecting method according to the second aspect of the present invention, the radically polymerizable substance is preferably at least one selected from the group consisting of acrylamide, N,N′-methylenebisacrylamide, and acrylamide derivatives.

(10) In the solution ejecting method according to the second aspect of the present invention, an inkjet method is preferably employed in the first ejection step.

(11) In the solution ejecting method according to the second aspect of the present invention, an inkjet method is preferably employed in the second ejection step.

(12) A method for forming an electrophoresis gel according to a third aspect of the present invention includes a solution ejecting method including a first ejection step of ejecting an electrophoresis-gel-forming monomer solution containing at least a monomer that forms a gel structure and a gel polymerization accelerator that activates a gel polymerization initiator and a second ejection step of ejecting a gel polymerization initiating solution containing the gel polymerization initiator onto the electrophoresis-gel-forming monomer solution.

(13) An electrophoresis gel according to a fourth aspect of the present invention is formed by a method for forming an electrophoresis gel, the method including a solution ejecting method including a first ejection step of ejecting an electrophoresis-gel-forming monomer solution containing at least a monomer that forms a gel structure and a gel polymerization accelerator that activates a gel polymerization initiator and a second ejection step of ejecting a gel polymerization initiating solution containing the gel polymerization initiator onto the electrophoresis-gel-forming monomer solution.

(14) An electrophoresis reaction instrument according to a fifth aspect of the present invention includes an electrophoresis gel formed by a method for forming an electrophoresis gel, the method including a solution ejecting method including a first ejection step of ejecting an electrophoresis-gel-forming monomer solution containing at least a monomer that forms a gel structure and a gel polymerization accelerator that activates a gel polymerization initiator and a second ejection step of ejecting a gel polymerization initiating solution containing the gel polymerization initiator onto the electrophoresis-gel-forming monomer solution.

### Advantageous Effects of Invention

According to the present invention, the timing at which the electrophoresis-gel-forming monomer solution starts to gelate can be controlled.

### BRIEF DESCRIPTION OF DRAWINGS

FIG. 1A is a first perspective view showing an overview of a solution ejecting method according to a first embodiment.

FIG. 1B is a second perspective view showing an overview of the solution ejecting method according to the first embodiment.

FIG. 1C is a third perspective view showing an overview of the solution ejecting method according to the first embodiment.

FIG. 2 is a perspective view showing an overview of a solution ejecting method according to a second embodiment.

FIG. 3A is a first sectional view showing an overview of a method for forming an electrophoresis gel according to an embodiment of the present invention.

FIG. 3B is a second sectional view showing an overview of the method for forming an electrophoresis gel according to an embodiment of the present invention.

FIG. 3C is a third sectional view showing an overview of the method for forming an electrophoresis gel according to an embodiment of the present invention.

FIG. 3D is a fourth sectional view showing an overview of the method for forming an electrophoresis gel according to an embodiment of the present invention.

### DESCRIPTION OF EMBODIMENTS

### “Electrophoresis-Gel-Forming Monomer Solution”

An electrophoresis-gel-forming monomer solution according to an embodiment of the present invention will be described.

The electrophoresis-gel-forming monomer solution of this embodiment contains at least a monomer that forms a gel structure and a gel polymerization accelerator that activates a gel polymerization initiator.

Examples of the monomer that forms a gel structure include radically polymerizable substances (substances polymerized using a radical as a reaction center), anionically polymerizable substances, cationically polymerizable substances, coordination polymerizable substances, and ring-opening polymerizable substances. Among them, radically polymerizable substances are preferably used because an electrophoresis gel having desired specifications can be formed at any timing.

An example of the radically polymerizable substances is at least one selected from the group consisting of acrylamide, N,N′-methylenebisacrylamide, and acrylamide derivatives.

Acrylamide is polymerized to form a main skeleton of an electrophoresis gel.

N,N′-methylenebisacrylamide is copolymerized with the acrylamide to cross-link the main skeleton of the electrophoresis gel.

In the electrophoresis-gel-forming monomer solution of this embodiment, the mixing ratio (mass ratio) of acrylamide and N,N′-methylenebisacrylamide is appropriately adjusted in accordance with the desired specifications of the electrophoresis gel and is preferably 19:1 to 49:1. In this embodiment, the mixing ratio (mass ratio) of acrylamide and N,N′-methylenebisacrylamide is, for example, 37.5:1.

An acrylamide derivative determines the charge distribution of the electrophoresis gel, that is, the pH distribution of the electrophoresis gel.

The acrylamide derivative is a substance obtained by introducing at least one substituent into acrylamide, and the acid dissociation constant (pKₐ) resulting from the substituent is in the range of 1 to 12.

Examples of the acrylamide derivative include derivatives obtained by substituting one hydrogen atom of carboxylic acid amide in acrylamide with, for example, a sulfonic group (—SO₃H), a carboxyl group (—COOH), a cyclic compound containing at least one of oxygen, nitrogen, sulfur, and the like, or an amino group (—NH₂, —NHR, or —NR₂).

In this embodiment, acrylamide derivatives having acid dissociation constants (plc) of, for example, 1, 3.1, 3.6, 4.6, 6.2, 7.0, 8.5, 9.3, 10.3, and 12 are used in combination in order to produce a desired electrophoresis gel.

The electrophoresis-gel-forming monomer solution of this embodiment is used as an acidic-electrophoresis-gel-forming monomer solution (hereinafter referred to as “acidic-gel-forming monomer solution”) or a basic-electrophoresis-gel-forming monomer solution (hereinafter referred to as “basic-gel-forming monomer solution”).

The acidic-gel-forming monomer solution contains acrylamide, N,N′-methylenebisacrylamide, and one or more acrylamide derivatives having different acid dissociation constants. The mixing ratio (mass ratio) of the acrylamide derivatives, that is, [the mass of acrylamide derivatives/the mass of acidic-gel-forming monomer solution (including acrylamide derivatives)] is appropriately adjusted in accordance with the desired specifications of the electrophoresis gel.

The basic-gel-forming monomer solution contains acrylamide, N,N′-methylenebisacrylamide, and one or more acrylamide derivatives having different acid dissociation constants. The mixing ratio (mass ratio) of the acrylamide derivatives, that is, [the mass of acrylamide derivatives/the mass of basic-gel-forming monomer solution (including acrylamide derivatives)] is appropriately adjusted in accordance with the desired specifications of the electrophoresis gel.

Tetramethylethylenediamine (TEMED) is used as the gel polymerization accelerator. When tetramethylethylenediamine is mixed with a gel polymerization initiator, radicals serving as activated species of gel polymerization are immediately generated. Consequently, ammonium persulfate (APS) suitable as a radical polymerization initiator for acrylamide can be made stably present without being deactivated.

The mixing ratio (mass ratio) of the gel polymerization accelerator to the electrophoresis-gel-forming monomer solution, that is, [the mass of gel polymerization accelerator/the mass of electrophoresis-gel-forming monomer solution (including gel polymerization accelerator)] is not particularly limited. The gel polymerization accelerator is mixed with each of the acidic-gel-forming monomer solution and basic-gel-forming monomer solution at a particular mixing ratio (mass ratio).

The electrophoresis-gel-forming monomer solution of this embodiment may contain a thickener for the purpose of appropriately adjusting the viscosity.

The thickener is not particularly limited, and is preferably glycerol because it does not affect the electrophoresis.

The mixing ratio (mass ratio) of the glycerol to the electrophoresis-gel-forming monomer solution, that is, [the mass of glycerol/the mass of electrophoresis-gel-forming monomer solution (including glycerol)] is not particularly limited, and is appropriately adjusted in accordance with the ejecting method of the electrophoresis-gel-forming monomer solution.

In the case where the electrophoresis-gel-forming monomer solution is an acidic-gel-forming monomer solution and this solution is ejected by an inkjet method, [the mass of glycerol/the mass of acidic-gel-forming monomer solution (including glycerol)] is, for example, adjusted to be 0.47.

In the case where the electrophoresis-gel-forming monomer solution is a basic-gel-forming monomer solution and this solution is ejected by an inkjet method, [the mass of glycerol/the mass of basic-gel-forming monomer solution (including glycerol)] is, for example, adjusted to be 0.40.

The electrophoresis-gel-forming monomer solution of this embodiment does not contain a gel polymerization initiator. Therefore, the gelation is caused to start by mixing a gel polymerization initiating solution containing a gel polymerization initiator with the electrophoresis-gel-forming monomer solution, whereby the timing at which gelation is caused to start can be controlled. Thus, the clogging of nozzles of an inkjet head due to gel formed of an electrophoresis-gel-forming monomer solution in the inkjet head can be prevented by ejecting the electrophoresis-gel-forming monomer solution using an inkjet head different from an inkjet head through which a gel polymerization initiating solution is ejected.

### “Solution Ejecting Method”

### (1) First Embodiment

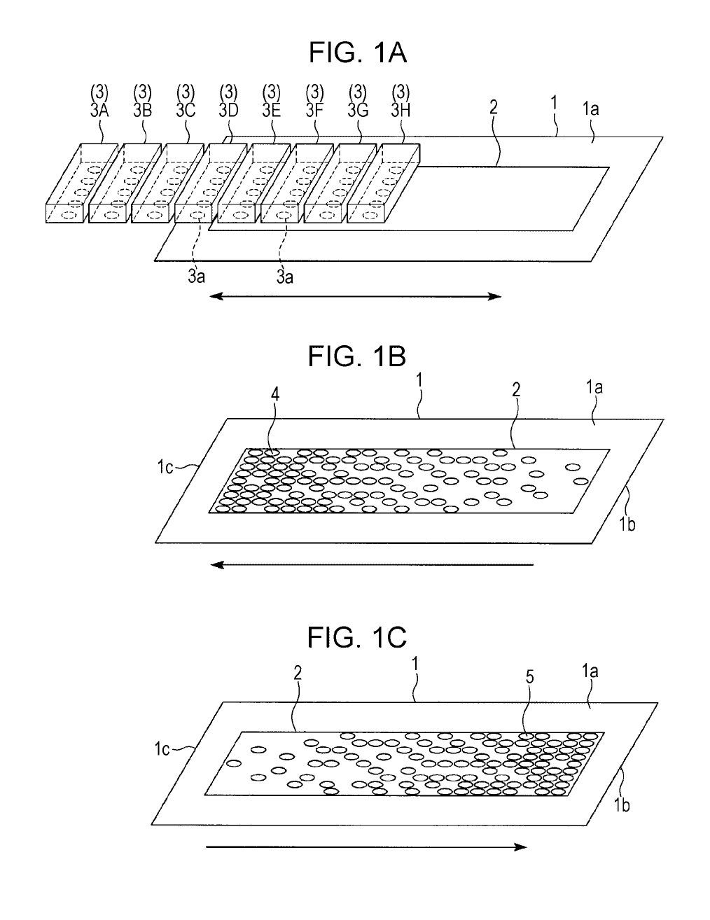

FIGS. 1A to 1C are perspective views showing an overview of a solution ejecting method according to a first embodiment.

The solution ejecting method of this embodiment includes a first ejection step of ejecting, by ejecting means 3, the above-described electrophoresis-gel-forming monomer solution onto a gel formation region 2 that has any shape and is disposed on an ejection surface (one surface) 1a of a base 1 serving as an ejection object and a second ejection step of ejecting, by the ejecting means 3, a gel polymerization initiating solution containing a gel polymerization initiator onto the electrophoresis-gel-forming monomer solution that has been ejected onto the ejection surface (one surface) 1a of the base 1 in the first ejection step.

Examples of the base 1 include a flat plate and a molded chip having any shape. In this embodiment, for example, a base having a rectangular shape in plan view is used as the base 1.

The base 1 is made of, for example, glass, resin, or ceramic.

Specific examples of the glass include quartz glass and non-alkali glass.

Specific examples of the resin include polyethylene terephthalate (PET) and polymethyl methacrylate (PMMA).

Specific examples of the ceramic include alumina and low temperature co-fired ceramic.

The gel formation region 2 is formed by performing surface modification of the surface 1a of the base 1. The surface modification is performed by physically coating the surface 1a of the base 1 with an organic compound having a chemical structure similar to that of a monomer contained in the electrophoresis-gel-forming monomer solution. Alternatively, the surface modification is performed by chemically forming a covalent bond between the organic compound and the surface 1a of the base 1. In other words, the gel formation region 2 is formed of a thin film composed of the above organic compound.

As described above, in the case where the electrophoresis-gel-forming monomer solution containing acrylamide, N,N′-methylenebisacrylamide, and acrylamide derivatives is used, the gel formation region 2 is preferably formed through a plasma graft polymerization treatment of acrylic acid, acrylamide, acrylamide derivatives, or the like. This imparts hydrophilicity to the obtained gel formation region 2, which allows an electrophoresis gel formed using the above-described electrophoresis-gel-forming monomer solution to strongly adhere to the gel formation region 2 formed on the surface 1a of the base 1.

In this embodiment, for example, a gel formation region that has a rectangular shape in plan view and is formed in the longitudinal direction of the base 1 is used as the gel formation region 2.

The ejecting means 3 is not particularly limited as long as fine droplets can be formed by the ejecting means 3 because multiple types of electrophoresis-gel-forming monomer solutions need to be mixed with each other directly on the surface 1a of the base 1. Examples of the ejecting means 3 include an inkjet head and a spray nozzle.

In this embodiment, it is also necessary to control the pitch between the fine droplets in a direction perpendicular to the surface 1a of the base 1. From this viewpoint, the ejecting means 3 is preferably an inkjet head rather than a spray nozzle that sprays the electrophoresis-gel-forming monomer solution.

In this embodiment, for example, an inkjet head is used as the ejecting means 3. Hereinafter, the ejecting means 3 is referred to as an inkjet head 3.

As shown in FIG. 1A, for example, the inkjet head 3 is constituted by eight inkjet heads 3A, 3B, 3C, 3D, 3E, 3F, 3G, and 3H each having many nozzles 3a disposed along a straight line at a predetermined pitch.

The inkjet heads 3A, 3B, 3C, 3D, 3E, 3F, 3G, and 3H are arranged in a row such that the directions in which the nozzles 3a of each of the inkjet heads 3A, 3B, 3C, 3D, 3E, 3F, 3G, and 3H extend are parallel to one another. The inkjet heads 3A, 3B, 3C, 3D, 3E, 3F, 3G, and 3H are sequentially disposed in a direction in which the inkjet head 3 scans the base 1 (a direction indicated by an arrow in FIG. 1A). In this embodiment, the scanning direction of the inkjet head 3 is a direction parallel to the longitudinal direction of the base 1.

The inkjet head 3 is not particularly limited, and a continuous inkjet head, an drop-on-demand inkjet head, and the like are used.

In the continuous inkjet head, for example, a charge control method in which charged fine droplets are controlled using an electric field is employed.

In the drop-on-demand inkjet head, a thermal (bubble) method, an electrostatic actuator method, or a piezoelectric method is employed.

The scanning direction of the inkjet head 3 is selected from one direction parallel to the longitudinal direction of the base 1 and both directions parallel to the longitudinal direction of the base 1 (reciprocal directions parallel to the longitudinal direction of the base 1) in accordance with the matter required when the electrophoresis gel is formed using the above-described electrophoresis-gel-forming monomer solution.

When priority is given to the alignment accuracy between the electrophoresis gel and the base 1, the scanning direction of the inkjet head 3 is one direction parallel to the longitudinal direction of the base 1.

When priority is given to the takt time, the scanning direction of the inkjet head 3 is both directions parallel to the longitudinal direction of the base 1 (reciprocal directions parallel to the longitudinal direction of the base 1).

In the solution ejecting method of this embodiment, first, a gel formation region 2 is formed on one surface 1a of a base 1 (FIG. 1A).

In this step, a region on the surface 1a of the base 1 is patterned so as to have a particular shape using a masking material such as a metal mask, a resist, or a Kapton tape. Only the patterned region is then subjected to a surface treatment to form the gel formation region 2.

The surface treatment method is not particularly limited. When the above-described electrophoresis-gel-forming monomer solution is used, for example, a plasma graft polymerization treatment of acrylic acid, acrylamide, acrylamide derivatives, or the like is employed.

After the completion of the plasma graft polymerization treatment, the masking material is removed and the surface 1a of the base 1 is washed.

The electrophoresis-gel-forming monomer solution is then ejected onto the gel formation region 2 on the surface 1a of the base 1 from the inkjet head 3 while the inkjet head 3 is scanned (moved) in the longitudinal direction of the base 1 (first ejection step).

In the first ejection step, an acidic-gel-forming monomer solution and a basic-gel-forming monomer solution are used as the electrophoresis-gel-forming monomer solution.

Each of the acidic-gel-forming monomer solution and basic-gel-forming monomer solution contains acrylamide, N,N′-methylenebisacrylamide, and one or more acrylamide derivatives having different acid dissociation constants.

In the first ejection step, one of the acidic-gel-forming monomer solution and basic-gel-forming monomer solution is ejected such that the droplets form a concentration gradient along the surface 1a of the base 1. The other of the acidic-gel-forming monomer solution and basic-gel-forming monomer solution is ejected such that the droplets form a concentration gradient opposite to the above concentration gradient.

In other words, in the first ejection step, for example, the acidic-gel-forming monomer solution is ejected onto the surface 1a of the base 1 from the inkjet head 3 such that the distribution density of droplets 5 of the acidic-gel-forming monomer solution increases from one end 1b to another end 1c of the base 1 as shown in FIG. 1B. Thus, the acidic-gel-forming monomer solution is ejected onto the surface 1a of the base 1 from the inkjet head 3 such that the concentration gradient of the acidic-gel-forming monomer solution increases from the one end 1b to the other end 1c of the base 1.

On the other hand, the basic-gel-forming monomer solution is ejected onto the surface 1a of the base 1 from the inkjet head 3 such that the distribution density of droplets 6 of the basic-gel-forming monomer solution increases to one end 1b from another end 1c of the base 1 as shown in FIG. 1C. Thus, the basic-gel-forming monomer solution is ejected onto the surface 1a of the base 1 from the inkjet head 3 such that the concentration gradient of the basic-gel-forming monomer solution increases to the one end 1b from the other end 1c of the base 1.

As described above, the acidic-gel-forming monomer solution and the basic-gel-forming monomer solution are separately ejected onto the surface 1a of the base 1 and each of the monomer solutions is ejected such that the concentration gradient is formed. As a result, the electrophoresis-gel-forming monomer solution can be ejected such that the pH gradient is formed in the longitudinal direction of the surface 1a of the base 1.

In this embodiment, the case where the acidic-gel-forming monomer solution and the basic-gel-forming monomer solution are each ejected one time has been shown as an example, but the present invention is not limited to the case. In the present invention, the number of ejections of the acidic-gel-forming monomer solution and basic-gel-forming monomer solution is appropriately adjusted in accordance with the electrophoresis gel having desired specifications.

The acidic-gel-forming monomer solution and the basic-gel-forming monomer solution are each normally a mixture of acrylamide, N,N′-methylenebisacrylamide, and one or more acrylamide derivatives having different acid dissociation constants. Therefore, each of the acrylamide derivatives is not always ejected to the gel formation region 2 at a preferred composition ratio.

In the first ejection step, various acrylamide derivatives may be independently ejected in order to precisely control the distribution density of droplets of the acidic-gel-forming monomer solution and basic-gel-forming monomer solution.

For example, a mixture of acrylamide and N,N′-methylenebisacrylamide is ejected from the inkjet head 3A and six types of acrylamide derivatives having different acid dissociation constants (pKₐ) (e.g., the acid dissociation constants (pKₐ) are 3.6, 4.6, 6.2, 7.0, 8.5, and 9.3) are separately ejected from the six inkjet heads 3B, 3C, 3D, 3E, 3F, and 3G. Thus, the acrylamide, N,N′-methylenebisacrylamide, and acrylamide derivatives are mixed with one another on the surface 1a of the base 1. This is equivalent to the case where the above-described electrophoresis-gel-forming monomer solution is ejected onto the surface 1a of the base 1.

In this case, the amount of the mixture of acrylamide and N,N′-methylenebisacrylamide ejected and the amount of the six types of acrylamide derivatives ejected are controlled such that the electrophoresis-gel-forming monomer solution ejected onto the surface 1a of the base 1 forms the concentration gradient in the longitudinal direction of the surface 1a of the base 1 in the end.

Next, for example, a gel polymerization initiating solution containing a gel polymerization initiator is ejected from the inkjet head 3H onto the electrophoresis-gel-forming monomer solution ejected onto the surface 1a of the base 1 in the first ejection step (second ejection step).

In other words, in the second ejection step, the gel polymerization initiator and a gel polymerization accelerator contained in the electrophoresis-gel-forming monomer solution are mixed just before the gelation of the electrophoresis-gel-forming monomer solution for the purpose of preventing the electrophoresis-gel-forming monomer solution from being gelated in the inkjet head 3.

When the gel polymerization initiator is mixed with the gel polymerization accelerator, radicals serving as activated species that trigger gel polymerization are immediately generated, but are deactivated over time. That is, the timing at which the gel polymerization initiator and the gel polymerization accelerator are mixed and the timing at which a monomer that forms a gel structure and a radical are mixed are important for the purpose of controlling the timing at which the electrophoresis-gel-forming monomer solution is gelated.

In this embodiment, since the electrophoresis-gel-forming monomer solution prepared by mixing a monomer that forms a gel structure and the gel polymerization accelerator in advance is used, the gel polymerization initiator and the gel polymerization accelerator are not mixed with each other until just before the gelation of the electrophoresis-gel-forming monomer solution. Therefore, the timing at which the electrophoresis-gel-forming monomer solution is gelated can be controlled by adjusting the timing at which the gel polymerization initiating solution containing the gel polymerization initiator is ejected onto the electrophoresis-gel-forming monomer solution, that is, the timing at which a radical is generated.

Ammonium persulfate (APS) is used as the gel polymerization initiator. When ammonium persulfate is mixed with the gel polymerization accelerator such as tetramethylethylenediamine (TEMED), radicals serving as activated species of gel polymerization are immediately generated and thus ammonium persulfate is suitable as a radical polymerization initiator for acrylamide.

Examples of a solvent for dissolving the gel polymerization initiator include glycerol, ethylene glycol, diethylene glycol, triethylene glycol, and polyethylene glycol.

About thirty minutes to one hour after the gel polymerization initiating solution is ejected onto the electrophoresis-gel-forming monomer solution ejected onto the gel formation region 2 of the base 1, the electrophoresis-gel-forming monomer solution starts to gelate and a desired electrophoresis gel is formed.

According to the solution ejecting method of this embodiment, the timing at which the electrophoresis-gel-forming monomer solution starts to gelate can be controlled. Therefore, the clogging of the nozzles 3a of the inkjet head 3 due to gel formed of the electrophoresis-gel-forming monomer solution in the inkjet head 3 can be prevented, and at the same time the inhibition of the gelation of the electrophoresis-gel-forming monomer solution caused by deactivation of radicals can be avoided. Thus, an electrophoresis gel having an immobilized pH gradient (IPG) can be formed.

Furthermore, the adhesiveness of the electrophoresis gel formed by gelation of the electrophoresis-gel-forming monomer solution to the surface 1a of the base 1 is improved by forming the gel formation region 2 on the surface 1a of the base 1 before the ejection of the electrophoresis-gel-forming monomer solution. Therefore, the electrophoresis gel can be formed in any shape regardless of the material of the base 1.

According to the solution ejecting method of this embodiment, in the first ejection step and second ejection step, the electrophoresis-gel-forming monomer solution can be ejected at a dot pitch of about several tens of micrometers by employing an inkjet method. As a result, an electrophoresis gel having a high-resolution pH gradient can be formed.

### (2) Second Embodiment

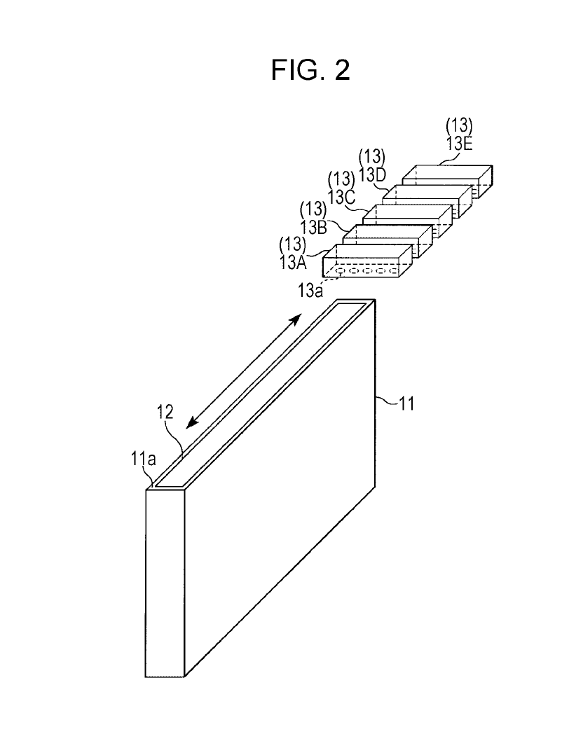

FIG. 2 is a perspective view showing an overview of a solution ejecting method according to a second embodiment.

In this embodiment, the case where, for example, a flat plate is used as a base 11 and a gel formation region 12 is formed on one side surface 11a of the base 11 is shown as an example.

The base 11 is not particularly limited, and is, for example, an acrylic plate having a thickness of 2 mm.

An inkjet head 13 is constituted by five inkjet heads 13A, 13B, 13C, 13D, and 13E each having many nozzles 13a disposed along a straight line at a predetermined pitch.

The inkjet heads 13A, 13B, 130, 13D, and 13E are arranged in a row such that the directions in which the nozzles 13a of each of the inkjet heads 13A, 13B, 13C, 13D, and 13E extend are parallel to one another. The inkjet heads 13A, 13B, 13C, 13D, and 13E are sequentially disposed in a direction in which the inkjet head 13 scans the side surface 11a of the base 11 (a direction indicated by an arrow in FIG. 2). In this embodiment, the scanning direction of the inkjet head 13 is a direction parallel to the longitudinal direction of the side surface 11a of the base 11.

In the solution ejecting method of this embodiment, first, a gel formation region 12 is formed on one side surface 11a of a base 11 in the same manner as in the first embodiment.

The electrophoresis-gel-forming monomer solution is ejected onto the gel formation region 12 on the side surface 11a of the base 11 from the inkjet head 13 while the inkjet head 13 is scanned (moved) in the longitudinal direction of the side surface 11a of the base 11 (first ejection step).

Also in this embodiment, in the first ejection step, the electrophoresis-gel-forming monomer solution is ejected in the same manner as in the first embodiment.

Next, a gel polymerization initiating solution containing a gel polymerization initiator is ejected from the inkjet head 13 onto the electrophoresis-gel-forming monomer solution ejected onto the side surface 11a of the base 11 in the first ejection step (second ejection step).

Also in this embodiment, in the second ejection step, the gel polymerization initiating solution is ejected in the same manner as in the first embodiment.

According to the solution ejecting method of this embodiment, as described above, the electrophoresis-gel-forming monomer solution can be ejected onto a narrow region and a region having a complicated shape. Therefore, a gel can be formed in a region in which the formation of a gel has been difficult.

“Method for Forming Electrophoresis gel”

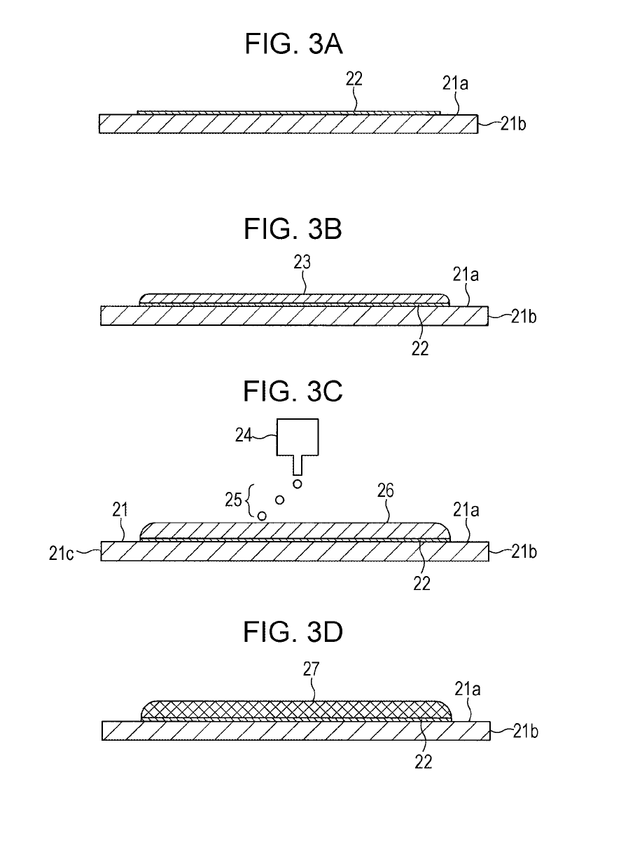

FIGS. 3A to 3D are sectional views schematically showing a method for forming an electrophoresis gel according to an embodiment of the present invention.

The method for forming an electrophoresis gel according to this embodiment includes the solution ejecting method of the first embodiment or the solution ejecting method of the second embodiment.

In the method for forming an electrophoresis gel according to this embodiment, first, a gel formation region 22 is formed on one surface 21a of a base 21 as shown in FIG. 3A (refer to FIG. 1A).

The same base as in the solution ejecting method of the first embodiment is used as the base 21.

The surface treatment of the surface 21a of the base 21 for forming the gel formation region 22 is performed by the same method as in the solution ejecting method of the first embodiment.

In this embodiment, for example, a polyethylene terephthalate film having a thickness of 200 μm is used as the base 21, a Kapton tape (polyimide tape, thickness 80 μm) having an open pattern with a length of 70 mm and a width of 3 mm formed therein is attached to the surface (front surface) 21a of the base 21, and a plasma graft polymerization surface treatment of acrylic acid or acrylamide is performed.

After the completion of the plasma graft polymerization surface treatment, the Kapton tape is removed and the surface is washed.

The contact angle of a water droplet on the gel formation region 22 measured is 20 degrees or less. From the comparison between this contact angle and the contact angle (60 degrees or more) on the surface 21a of the base 21, it has been confirmed that the gel formation region 22 is a surface having high hydrophilicity.

Next, as shown in FIG. 3B, pure water or an aqueous solution prepared by mixing a carrier ampholyte in pure water is dropped onto the gel formation region 22 of the surface 21a of the base 21 using, for example, a pipette, a dispenser, or an inkjet method to form a liquid pool 23 in the gel formation region 22. Herein, the liquid pool 23 is formed so as to uniformly spread to the entire gel formation region 22.

The pure water or aqueous solution that forms the liquid pool 23 may optionally contain a gel polymerization accelerator such as tetramethylethylenediamine.

In this embodiment, the size (the size (area) in plan view) of the liquid pool 23 is set to be, for example, 70 mm in length×3 mm in width.

In the subsequent step, the liquid pool 23 plays an important role for favorably mixing the above-described electrophoresis-gel-forming monomer solution and gel polymerization initiating solution.

The liquid pool 23 also plays an important role for forming an electrophoresis gel having a desired thickness. That is, the absence of the liquid pool 23 remarkably increases the production time of the electrophoresis gel.

In this embodiment, for example, the solutions are ejected onto the gel formation region 22 in a total amount of 140 μL, and the thickness after the gel polymerization is adjusted to be 500 μm.

In this embodiment, for example, 67.65 μL of pure water for forming the liquid pool 23 is dropped onto the gel formation region 22 using a pipette.

Next, as shown in FIG. 3C, the electrophoresis-gel-forming monomer solution is ejected onto the liquid pool 23 on the surface 21a of the base 21 from an inkjet head 24 in the same manner as in the solution ejecting method of the first embodiment or second embodiment (first ejection step).

In other words, in the first ejection step, for example, when the electrophoresis-gel-forming monomer solution is an acidic-gel-forming monomer solution, the acidic-gel-forming monomer solution is ejected onto the surface 21a of the base 21 from the inkjet head 24 as shown in FIG. 3C such that the distribution density (ejection density) of droplets 25 of the acidic-gel-forming monomer solution increases from one end 21b to another end 21c of the base 21.

Thus, the acidic-gel-forming monomer solution is ejected onto the surface 21a of the base 21 from the inkjet head 24 such that the concentration gradient of the acidic-gel-forming monomer solution increases from the one end 21b to the other end 21c of the base 21.

In this embodiment, for example, the amount of the acidic-gel-forming monomer solution ejected is 39.45 μL.

On the other hand, when the electrophoresis-gel-forming monomer solution is a basic-gel-forming monomer solution, the basic-gel-forming monomer solution is ejected onto the surface 21a of the base 21 from the inkjet head 24 as shown in FIG. 3C such that the distribution density (ejection density) of droplets 25 of the basic-gel-forming monomer solution increases to one end 21b from another end 21c of the base 21.

Thus, the basic-gel-forming monomer solution is ejected onto the surface 21a of the base 21 from the inkjet head 24 such that the concentration gradient of the basic-gel-forming monomer solution increases to the one end 21b from the other end 21c of the base 21.

In this embodiment, for example, the amount of the basic-gel-forming monomer solution ejected is 26.90 μL.

In this embodiment, the case where the acidic-gel-forming monomer solution and the basic-gel-forming monomer solution are each ejected one time has been shown as an example, but the present invention is not limited to the case. In the present invention, the number of ejections of the acidic-gel-forming monomer solution and basic-gel-forming monomer solution is appropriately adjusted in accordance with the electrophoresis gel having desired specifications.

That is, in the first ejection step, various acrylamide derivatives may be independently ejected in the same manner as in the solution ejecting method of the first embodiment in order to precisely control the distribution density of droplets of the acidic-gel-forming monomer solution and basic-gel-forming monomer solution.

Next, as shown in FIG. 3C, a gel polymerization initiating solution containing a gel polymerization initiator is ejected from the inkjet head 24 onto the electrophoresis-gel-forming monomer solution ejected onto the liquid pool 23 on the surface 21a of the base 21 in the same manner as in the solution ejecting method of the first embodiment or second embodiment (second ejection step).

In this embodiment, for example, 20% ammonium persulfate is used as the gel polymerization initiator, and a gel polymerization initiating solution prepared by mixing 20% ammonium persulfate and glycerol at a volume ratio of 1:1 is used.

In this embodiment, the amount of the gel polymerization initiating solution ejected is set to be 7 μL.

Thus, an electrophoresis-gel-forming mixture solution 26 is ejected onto the gel formation region 22 formed on the surface 21a of the base 21.

After the electrophoresis-gel-forming mixture solution 26 is left to stand for about 30 minutes to 1 hour, the electrophoresis-gel-forming mixture solution 26 starts to gelate and a desired electrophoresis gel 27 (FIG. 3D) is formed.

In this embodiment, since a radical reaction is employed, an electrophoresis-gel-forming process including the first ejection step and the second ejection step is preferably performed in a nitrogen atmosphere to avoid the influence of oxygen that suppresses the gel polymerization reaction.

Next, the electrophoresis gel 27 is washed with a cleaning liquid to remove salts of sodium ions and the like contained in the electrophoresis gel 27 and monomers that are not subjected to the gel polymerization and are contained in the electrophoresis gel 27.

For example, pure water or an aqueous solution prepared by mixing a small amount of carrier ampholyte in pure water is used as the cleaning liquid.

The electrophoresis gel 27 is washed by immersing, in pure water or the aqueous solution, the base 21 on which the electrophoresis gel 27 is formed and shaking them using a shaker or the like.

In this embodiment, a step of immersing, in pure water, the base 21 on which the electrophoresis gel 27 is formed and shaking them at 40 rpm for 20 minutes is repeatedly performed three times. Note that the pure water is replaced each time a single step of washing is completed.

Next, immediately after the completion of the washing, the base 21 on which the electrophoresis gel 27 is formed is dried in a desiccator.

According to the method for producing an electrophoresis gel of this embodiment, the timing at which the electrophoresis-gel-forming monomer solution starts to gelate can be controlled. Therefore, the clogging of the nozzles of the inkjet head 24 due to gel formed of the electrophoresis-gel-forming monomer solution in the inkjet head 24 can be prevented, and at the same time the inhibition of the gelation of the electrophoresis-gel-forming monomer solution caused by deactivation of radicals can be avoided. Thus, an electrophoresis gel having an immobilized pH gradient (IPG) can be formed.

The electrophoresis gel produced by the method for producing an electrophoresis gel according to this embodiment has a high-resolution pH gradient and contains a smaller amount of impurities.

The electrophoresis gel is formed on a base by using the method for producing an electrophoresis gel according to this embodiment, whereby an electrophoresis reaction instrument including the electrophoresis gel is obtained.

The electrophoresis reaction instrument of this embodiment is obtained by, for example, directly disposing the above-described electrophoresis gel on one surface of the base 11 shown in FIG. 2.

For example, a plate-shaped injection molded product formed of polymethyl methacrylate (PMMA) or the like is used as the base 11.

The electrophoresis reaction instrument of this embodiment is applied to, for example, an automated two-dimensional electrophoresis apparatus.

An automated two-dimensional electrophoresis apparatus includes fixing means for fixing a second separation unit (sample separation unit) used to perform second-dimensional separation of a sample, holding means with an arm for holding a gel-attached support that supports a first medium used to perform first-dimensional separation, and driving means for changing the relative positions of the fixing means and holding means by moving the fixing means and/or the holding means.

In this automated two-dimensional electrophoresis apparatus, for example, the electrophoresis reaction instrument of this embodiment is used as the first medium used to perform first-dimensional separation.

### INDUSTRIAL APPLICABILITY

The present invention can be applied to polyacrylamide gel electrophoresis or agarose gel electrophoresis that separates biopolymers such as proteins, DNA, and RNA. In particular, the present invention can be suitably applied to two-dimensional electrophoresis including isoelectric focusing and SDS-PAGE electrophoresis.

### REFERENCE SIGNS LIST

1 base

2 gel formation region

3 ejecting means (inkjet head)

3A, 3B, 3C, 3D, 3E, 3F, 3G, 3H inkjet head

4 droplet of acidic-gel-forming monomer solution

5 droplet of basic-gel-forming monomer solution

11 base

12 gel formation region

13 inkjet head

21 base

22 gel formation region

23 liquid pool

24 inkjet head

25 droplet

26 electrophoresis-gel-forming mixture solution

27 electrophoresis gel

1.-14. (canceled)

15. A solution ejecting method comprising:
ejecting an electrophoresis-gel-forming monomer solution containing at least a monomer that contributes to formation of a gel structure and a gel polymerization accelerator that activates a gel polymerization initiator such that a concentration gradient is formed in one direction of an ejection surface of an ejection object; and
ejecting a gel polymerization initiating solution containing the gel polymerization initiator onto the electrophoresis-gel-forming monomer solution.

16. The solution ejecting method according to claim 15, wherein, in a case of ejecting the electrophoresis-gel-forming monomer solution, the electrophoresis-gel-forming monomer solution is ejected a plurality of times.

17. The solution ejecting method according to claim 15, wherein the concentration gradient is formed on the basis of a distribution density of the electrophoresis-gel-forming monomer solution.

18. The solution ejecting method according to claim 17, wherein, in a case of ejecting the electrophoresis-gel-forming monomer solution, an acidic first monomer solution and a basic second monomer solution are ejected as the monomer.

19. The solution ejecting method according to claim 18, wherein the first monomer solution and the second monomer solution are ejected in a separated manner.

20. The solution ejecting method according to claim 19, wherein the first monomer solution and the second monomer solution are ejected such that a tendency of the distribution density of the first monomer solution from one end to another end of the ejection surface is opposite to a tendency of the distribution density of the second monomer solution from the one end to the other end of the ejection surface.

21. The solution ejecting method according to claim 15, wherein, in a case of ejecting the electrophoresis-gel-forming monomer solution, a plurality of monomers having different acid dissociation constants or a mixture of the plurality of monomers is used as the monomer.

22. The solution ejecting method according to claim 21, wherein, in a case of ejecting the electrophoresis-gel-forming monomer solution, the plurality of monomers or the mixture of the plurality of monomers is ejected from a plurality of ejection units in a separated manner.

23. The solution ejecting method according to claim 15, wherein, in a case of ejecting the electrophoresis-gel-forming monomer solution, the electrophoresis-gel-forming monomer solution is ejected by an inkjet method.

24. The solution ejecting method according to claim 15, wherein, in a case of ejecting the gel polymerization initiating solution, the gel polymerization initiating solution is ejected by an inkjet method.

25. The solution ejecting method according to claim 15, wherein the monomer is a radically polymerizable substance.

26. The solution ejecting method according to claim 25, wherein the radically polymerizable substance is at least one selected from the group consisting of acrylamide, N,N′-methylenebisacrylamide, and acrylamide derivatives.

27. The solution ejecting method according to claim 15, wherein the gel polymerization accelerator is tetramethylethylenedia mine.

28. The solution ejecting method according to claim 15, wherein the gel polymerization initiating solution is ejected after the electrophoresis-gel-forming monomer solution is ejected.

29. The solution ejecting method according to claim 15, wherein, in a case of ejecting the electrophoresis-gel-forming monomer solution, the electrophoresis-gel-forming monomer solution is ejected with a thickener contained therein.

30. The solution ejecting method according to claim 15, wherein, before the electrophoresis-gel-forming monomer solution and the gel polymerization initiating solution are ejected, a plasma graft polymerization treatment is performed on the ejection surface of the ejection object.

31. The solution ejecting method according to claim 15, wherein the gel polymerization accelerator is ejected from a first ejection unit and the gel polymerization initiator is ejected from a second ejection unit different from the first ejection unit.

32. The solution ejecting method according to claim 15, wherein a flat plate is used as the ejection object and one surface of the flat plate is used as the ejection surface.

33. The solution ejecting method according to claim 15, wherein a flat plate is used as the ejection object and one side surface of the flat plate is used as the ejection surface.

34. An electrophoresis reaction instrument comprising:
a first ejection unit from which an electrophoresis-gel-forming monomer solution containing at least a monomer that contributes to formation of a gel structure and a gel polymerization accelerator that activates a gel polymerization initiator is ejected such that a concentration gradient is formed in one direction of an ejection surface of an ejection object; and
a second ejection unit from which a gel polymerization initiating solution containing the gel polymerization initiator is ejected onto the electrophoresis-gel-forming monomer solution.
